(19) United States
(12) Patent Application Publication
(10) Pub. No.: US 2007/0080633 A1
(43) Pub. Date: Apr. 12, 2007

(54) Plasma display panel

(76) Inventors: Jeong-Nam Kim, Suwon-si (KR); Hyoung-Bin Pakr, Suwon-si (KR)

Correspondence Address: Robert E. Bushnell;Suite 300, 1522 K Street, N.W., Washington, DC, 20005-1202, US

(21) Appl. No.: 11/526,022

(22) Filed: Sep. 25, 2006

(30) Foreign Application Priority Data
Oct. 11, 2005 (KR) 10-2005-0095370

(51) Int. Cl. H01J 1/62

(52) U.S. Cl. 313/506

(57) ABSTRACT

A plasma display panel (PDP) with improved luminous efficiency by having a low discharge current. The PDP includes a first substrate, a second substrate facing the first substrate with a distance therebetween, multiple discharge cells located between the first substrate and the second substrate, address electrodes extending in a first direction on the first substrate and corresponding to the discharge cells, and first and second electrodes electrically isolated from the address electrodes and extending in a second direction crossing the first direction. Each of the address electrodes includes an elongated portion and a pair of protruding portions. Each of the first electrodes includes a first elongated portion and a first floating portion. Each of the second electrodes includes a second elongated portion and a second floating portion.

### CLAIM OF PRIORITY

This application makes reference to, incorporates the same herein, and claims all benefits accruing under 35 U.S.C. §119 from an application earlier filed in the Korean Intellectual Property Office on Oct. 11, 2005 and there duly assigned Serial No. 10-2005-0095370.

### BACKGROUND OF THE INVENTION

1. Field of the Invention

The present invention relates to a plasma display panel (PDP). More particularly, the present invention relates to a PDP with improved luminous efficiency by limiting an amount of discharge current.

2. Description of the Related Art

Generally, a PDP excites phosphors using vacuum ultraviolet (VUV) rays illuminated from a plasma generated from a gas discharge, and expresses images using visible light of red, green, and blue colors emitted from the phosphors. A PDP can have a very wide screen of larger than 60 inches, while having a thickness of only about 10 cm. Also, a PDP is an emissive display like a cathode ray tube (CRT), and thus it does not exhibit distortion caused by a degree of color representation and a viewing angle. Compared with a liquid crystal display (LCD), a PDP can be fabricated by a simple process, and thus it is advantageous in terms of productivity and cost. As a result, the PDP has been highlighted as a flat panel display for televisions and industrial purposes.

A three-electrode surface-discharge type is one exemplary structure of a PDP. The three-electrode surface-discharge type of PDP will be described as an example. A PDP is configured with a front substrate and a rear substrate which face each other and are filled with a discharge gas therebetween. The front substrate includes sustain electrodes and scan electrodes formed on the same plane. The rear substrate includes address electrodes which extend perpendicular to the sustain electrodes and the scan electrodes, and are apart from the front substrate by a distance.

A PDP selects discharge cells to be turned on during an address discharge between the scan electrodes and the address electrodes which are controlled independently. The PDP produces an image during a sustain discharge between the sustain electrodes and the scan electrodes of the selected discharge cells. Since the scan electrodes and the address electrodes are respectively disposed on opposite substrates, the discharge distance between these two electrodes becomes long. As a result, power consumption caused as a result of the address discharge can be significant.

The opposed discharge structure generally increases discharge gaps, each formed between the sustain electrode and the scan electrode, thereby increasing a discharge voltage. Also, the discharge current can increase because voltage is applied to the entire cross-sectional area of the sustain electrodes and the scan electrodes. Accordingly, power consumption can increase, and luminous efficiency can be lowered. What is therefore needed is an improved design for a PDP that allows for lower voltage operation, higher luminance and more efficient discharge.

### SUMMARY OF THE INVENTION

It is therefore an object of the present invention to provide for an improved design for a PDP.

It is also an object of the present invention to provide a design for a PDP that shortens the distance between electrodes used during the address discharge.

The present invention has been made in an effort to provide a plasma display panel (PDP) having advantages of improving luminous efficiency by limiting an amount of discharge current.

The address electrodes, the scan electrodes, and the sustain electrodes are all formed on the front substrate, and the sustain electrodes and the scan electrodes are formed in an opposed discharge structure such that they are arranged in the direction crossing the address electrodes. The sustain electrodes and the scan electrodes are arranged on neighboring discharge cells and are commonly shared.

These and other objects can be achieved by a PDP that includes a first substrate, a second substrate facing the first substrate and separated from the first substrate by a distance, a plurality of discharge cells arranged between the first substrate and the second substrate, a plurality of address electrodes arranged on the first substrate at locations corresponding to the plurality of discharge cells, the plurality of address electrodes extending in a first direction and a plurality of first and second electrodes electrically isolated from the address electrodes and extending in a second direction that crosses the first direction, wherein each of the plurality of address electrodes includes an elongated portion extending in the first direction and a plurality of protruding portions, each of said protruding portions extending in the second direction from the elongated portion. Each of the plurality of first electrodes includes a first elongated portion alternately arranged between the discharge cells and extending in the first direction and a first floating portion arranged on the first substrate to float on the first elongated portion and extend toward the second substrate. Each of the plurality of second electrodes includes a second elongated portion arranged between the discharge cells and extending parallel to and alternately with the first elongated portion and corresponding to the protruding portions of the address electrodes and a second floating portion to float on the second elongated portion and face a first floating portion and extend parallel to the first floating portion and while being between the discharge cells.

Each first and each second elongated portion can extend in the first direction and within a boundary between a pair of said plurality of discharge cells neighboring in the second direction. The protruding portions of the address electrodes can protrude from the elongated portion corresponding to the discharge cells formed at both sides of respective second electrodes, each of which is taken as a central line.

The PDP can further include a first dielectric layer covering the plurality of address electrodes, a second dielectric layer covering the first dielectric layer and covering the first elongated portion and the second elongated portion arranged on the first dielectric layer and a third dielectric layer covering the first floating portions and the second floating portions arranged on the second dielectric layer. The first dielectric layer and the second dielectric layer can each be arranged over an entire surface of the first substrate and the third dielectric layer can arranged at locations corresponding to first floating portions and second floating portions. Alternatively, the first dielectric layer can be arranged over an entire surface of the first substrate and the second dielectric layer and the third dielectric layer can each be arranged at locations corresponding to first floating portions and second floating portions. The second dielectric layer can have a thickness that is smaller than a thickness of the first dielectric layer. With respect to a vertical cross-section area of the first and second substrates, the first elongated portion can have a cross-sectional area that is smaller than that of the first floating portion. The first elongated portion can have a thickness that is smaller than that of the address electrode. The second elongated portions can have a thickness that is smaller than that of the address electrode. The first floating portions and the second floating portions can be arranged separately on respective ones of the plurality of discharge cells. The PDP can also include phosphor layers arranged on the second substrate on an inner surface of the plurality of discharge cells. A thickness of each of the first and the second floating portions can be greater than a width of each of the first and the second elongated portions.

According to another aspect of the present invention, there is provided a plasma display panel that includes a first substrate, a second substrate facing the first substrate and separated from the first substrate by a distance, a plurality of barrier ribs arranged between the first and the second substrate and adapted to partition a space between the first and the second substrates into a plurality of discharge cells, phosphor layers arranged on the rear substrate and on sidewalls of the plurality of barrier ribs within the plurality of discharge cells, a plurality of address electrodes arranged on the first substrate in a first direction, the address electrodes being covered by a first dielectric layer and an elongated portion of a sustain electrode and an elongated portion of a scan electrode formed on the first dielectric layer and extending in a second direction that crosses the first direction and being covered by a second dielectric layer, the plurality of barrier ribs being arranged between each of the elongated portions of the sustain and scan electrodes and the rear substrate.

The PDP can also include a floating portion of the sustain electrode arranged on the second dielectric layer at a location that corresponds to the elongated portion of the sustain electrode, a floating portion of the scan electrode arranged on the second dielectric layer at a location that corresponds to the elongated portion of the scan electrode and a third dielectric layer that covers the floating portions of each of the sustain and the scan electrodes, the floating portions of each of the sustain and the scan electrodes being further from the rear substrate than the plurality of barrier ribs, the floating portion and the elongated portion of each of the sustain and the scan electrodes being arranged above the plurality of barrier ribs and not above the plurality of discharge cells. The elongated portion of each of the sustain and the scan electrodes can be thinner than the address electrodes, the floating portion for each of the sustain and the scan electrodes can be thicker than the address electrodes and be thicker than a width of floating portions of each of the sustain and the scan electrodes. Each of the plurality of address electrodes can include an elongated portion arranged above ones of the plurality of barrier ribs and a plurality of protruding portions, each extending from an elongated portion into a region above ones of the plurality of discharge cells. The protruding portions can be formed in pairs, ones of each pair can be arranged on either side of a scan electrode and over separate discharge cells.

### BRIEF DESCRIPTION OF THE DRAWINGS

FIG. 1 is an exploded perspective view illustrating a part of a PDP according to the first embodiment of the present invention;

FIG. 2 is a top plan view illustrating an arrangement of discharge cells and electrodes illustrated in FIG. 1;

FIG. 3 is a cross-sectional view of the PDP taking along the line III-III of FIG. 1;

FIG. 4 is a perspective view illustrating a structure of the electrodes illustrated in FIG. 1; and

FIG. 5 is a cross-sectional view illustrating a PDP according to the second embodiment of the present invention.

### DETAILED DESCRIPTION OF THE INVENTION

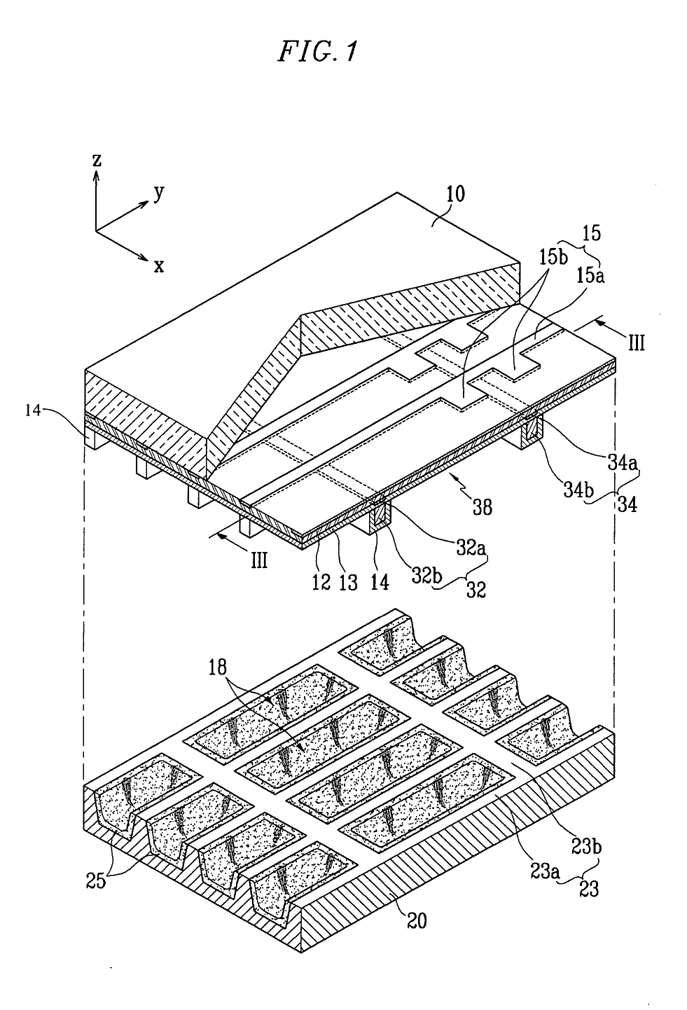

Turning now to the figures, FIG. 1 is an exploded perspective view illustrating a part of a PDP according to the first embodiment of the present invention. As illustrated, the PDP according to the first embodiment includes a first substrate 10 (hereinafter referred to as “front substrate”) and a second substrate 20 (hereinafter referred to as “rear substrate”) which face each other in parallel while having a distance between them.

A plurality of discharge cells 18 are partitioned between the front substrate 10 and the rear substrate 20. The discharge cells 18 are particularly partitioned by barrier ribs 23, which are formed by etching the rear substrate 20. In addition, although not illustrated, the discharge cells can be partitioned by barrier ribs that are additionally formed on the rear substrate.

Each of the barrier ribs 23 includes a first barrier rib member 23a and a second barrier rib member 23b. The first barrier rib member 23a extends in a first direction (i.e., in the y-axis direction of FIG. 1), and the second barrier rib member 23b extends in a second direction (i.e., in the x-axis direction of FIG. 1) crossing the first direction and extending between the first barrier rib members 23a. The first barrier rib members 23a and the second barrier rib members 23b form the discharge cells 18 having a matrix shape. This specific structure allows is effective in preventing cross-talk. Alternatively, the first barrier rib members 23a extending in the y-axis direction can form the discharge cells that have the shape of stripes. In the first embodiment of the present invention, the discharge cells 18 have a rectangular shape from a top plane view. That is, each discharge cell 18 is formed in a cuboidal shape having an open top.

The discharge cells 18 are filled with a discharge gas that is necessary for a plasma discharge, such as xenon (Xe) or neon (Ne). The discharge cells 18 include phosphor layers 25 of red (R), green (G), and blue (B) colors to illuminate visible light of R, G, and B colors. The phosphor layers 25 include phosphors coated on the bottom surface of each of the discharge cells 18 and on inner sidewall surfaces of the barrier ribs 23.

To generate a plasma discharge within the discharge cells 18, address electrodes 15, first electrodes 32 (hereinafter referred to as “sustain electrodes”), and second electrodes 34 (hereinafter referred to as “scan electrodes”) are formed on the front substrate 10 such that they correspond to the individual discharge cells 18. The address electrodes 15 extend along the y-axis direction across the front substrate 10, and are arranged in parallel while corresponding to the discharge cells 18 with respect to the x-axis direction. As illustrated in FIG. 1, the address electrodes 15 are arranged to pass over the top of the discharge cells 18.

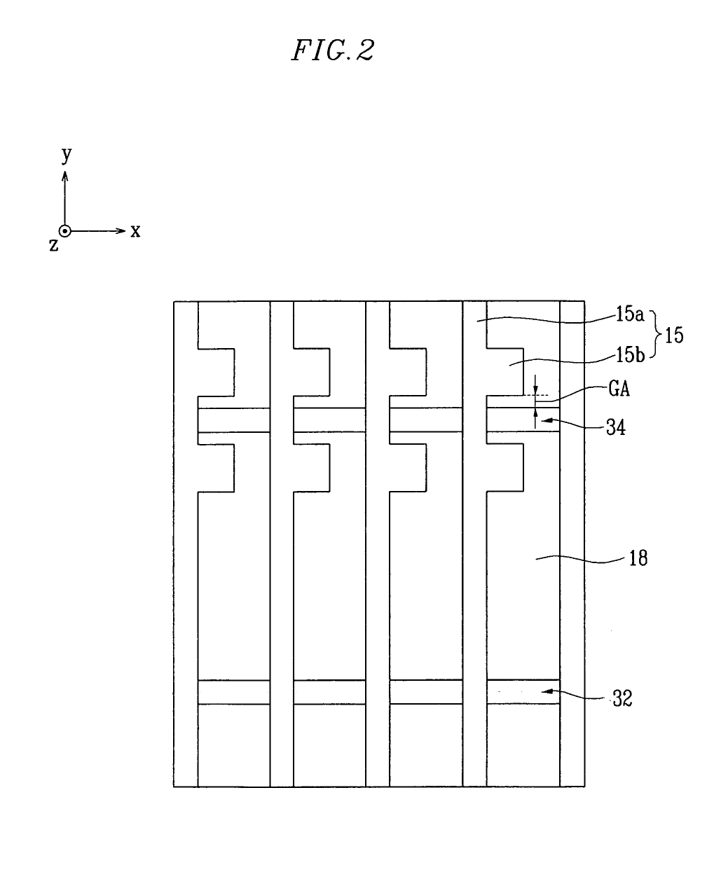

Each of the address electrodes 15 includes an elongated portion 15a formed over the front substrate 10 at locations corresponding to the respective first barrier rib members 23a. Further, each of the address electrodes 15 includes protruding portions 15b protruding to the inside of the discharge cells 18 from the elongated portion 15a to select the discharge cells 18 on either side of the second barrier rib members 23b that extend in the x-axis direction (refer to FIG. 2). That is, the elongated portions 15a are extended along a boundary between a pair of rows of the discharge cells 18 neighboring in the x-axis direction, i.e., along the y-axis corresponding to the respective first barrier rib members 23a. Because the elongated portions 15a are between and not above the discharge cells 18, the elongated portions 15a do not block visible light since the elongated portions 15a are formed over the front substrate 10 at areas corresponding to the respective first barrier rib members 23a, which are non-discharge areas. Hence, the elongated portions 15a can be formed using an opaque and highly conductive metal.

With respect to the xy plane, the protruding portions 15b protrude to the inside of the discharge cells 18 on either side of a respective scan electrodes 34. The protruding portions 15b can have various shapes when viewed from above. In FIGS. 1 and 2, a rectangular shape is illustrated as an exemplary top plan view of the protruding portions 15b in the present embodiment. A potential difference between the scan electrodes 34 and the protruding portions 15b provokes an address discharge to select discharge cells 18 and to simultaneously minimize blockage of visible light during a sustain discharge.

As illustrated in FIG. 2, taking the scan electrode 34 as a central line, the protruding portions 15b are formed over the respective discharge cells 18 that are adjacently disposed in the y-axis direction. Also, although not illustrated, the protruding portions can be integrally formed with a pair of the discharge cells neighboring in the y-axis direction.

In any of these scenarios, a pair of protruding portions 15b of the address electrode 15 commonly share a single scan electrode 34 corresponding to the discharge cells 18 that are adjacent to each other in the y-axis direction. Thus, the protruding portions 15b take part in an address discharge of the pair of discharge cells 18 that are adjacent to each other in the y-axis direction.

A first dielectric layer 12 is formed over the entire surface of the front substrate 10, covering the address electrodes 15 (i.e., both the elongated portions 15a and the protruding portions 15b). The first dielectric layer 12 generates and accumulates wall charges during a plasma discharge, while electrically insulating the address electrodes 15 from the sustain electrodes 32 and the scan electrodes 34.

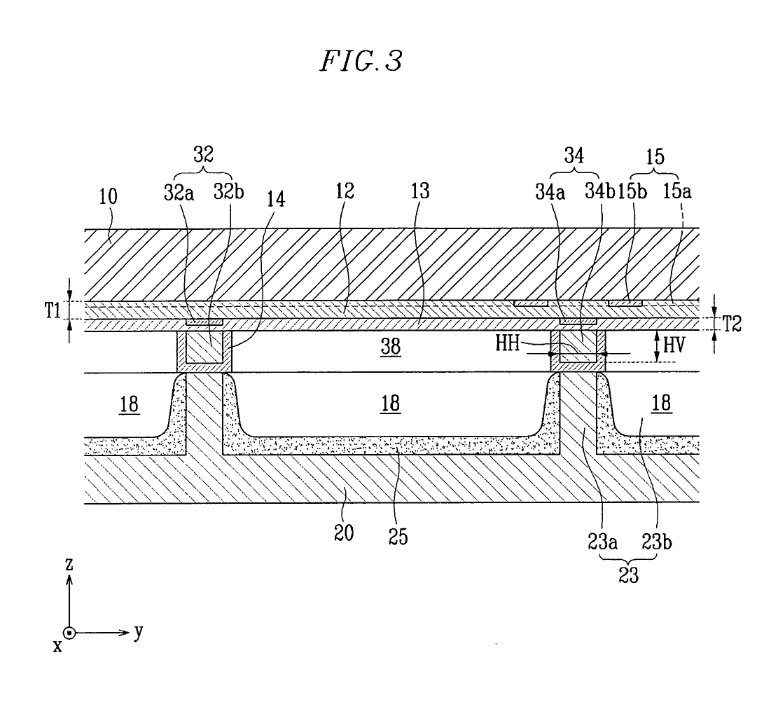

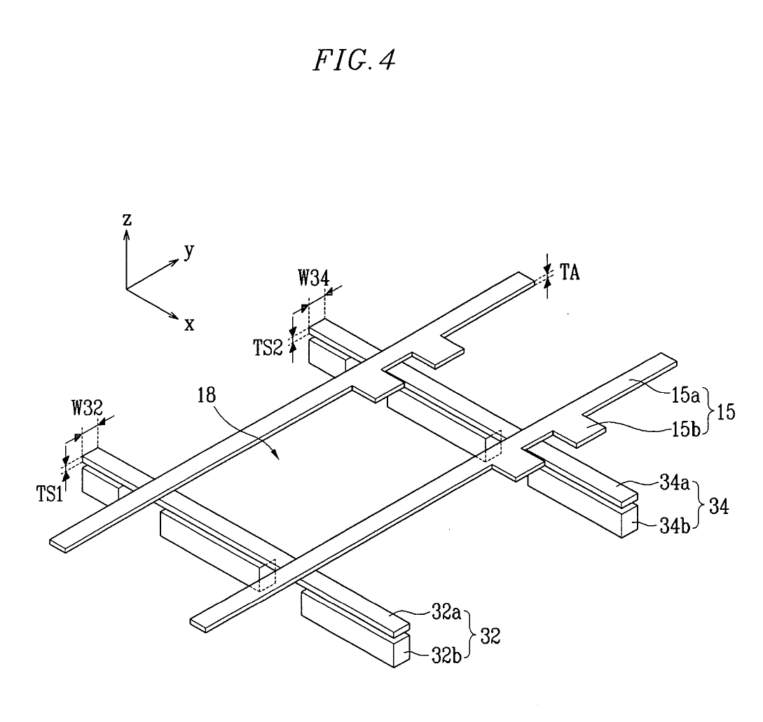

Turning now to FIGS. 3 and 4, FIG. 3 is a cross-sectional view taking along the line III-III of FIG. 1, and FIG. 4 is a perspective view illustrating the structure of the electrodes of FIG. 1. With reference to FIGS. 3 and 4, the sustain electrodes 32 and the scan electrodes 34 extend on the first dielectric layer 12 of the front substrate 10 along a second direction (i.e., the x-axis direction in these drawings). The sustain electrodes 32 and the scan electrodes 34 are alternately arranged in the y-axis direction between the discharge cells 18, thus forming an opposed discharge structure between the respective discharge cells 18.

The sustain electrodes 32 that extend in the x-axis direction each include a first elongated portion 32a and first floating portions 32b. A first elongated portion 32a is arranged between every other discharge cell along the y-axis direction. The first floating portions 32b float below the first elongated portions 32a and extend toward the rear substrate 20.

In addition, the scan electrodes 34 are formed in parallel with the sustain electrodes 32. More specifically, each scan electrode 34 includes a second elongated portion 34a and a second floating portion 34b. The second elongated portion 34a is arranged between every other discharge cell 18 in parallel to and alternating with the first elongated portion 32a. The second floating portion 34b floats below the second elongated portion 34a and in parallel with the first floating portions 32b between the discharge cells 18, and extends toward the rear substrate 20. The second floating portion 34b respectively corresponds to a pair of protruding portions 15b of the address electrode 15.

Referring to FIG. 4, the first floating portions 32b and the second floating portions 34b are formed as separate structures, each corresponding to a discharge cell 18. Although not illustrated, each of the first floating portions 32b and the second floating portions 34b can extend in the x-axis direction and be integrally formed with a group of discharge cells 18 disposed in the x-axis direction.

A voltage signal is applied to the first elongated portion 32a and the second elongated portion 34a. A first floating portion 32b and a second floating portion 34b are arranged in an opposed discharge structure at both sides of a discharge cell 18 to form a discharge gap, which causes generation of an opposed discharge. When the first elongated portion 32a is applied a voltage signal, a certain level of voltage that is lower than the voltage signal is applied to the first floating portion 32b. Similarly, when the second elongated portion 34a is applied a voltage signal, a certain level of voltage that is lower than the voltage signal is applied to the second floating portion 34b. The first floating portions 32b and the second floating portions 34b are the portions that actually generate the opposed discharge within the discharge cells 18.

In addition, the sustain electrode 32 and the scan electrode 34 alternately correspond to the second barrier rib members 23b in the y-axis direction. As a result, each of the sustain electrodes 32 and the scan electrodes 34 are commonly shared by a pair of neighboring discharge cells 18, and thus, each of the sustain electrodes 32 and the scan electrodes 34 takes part in a sustain discharge of two neighboring discharge cells 18.

The first elongated portions 32a of the sustain electrodes 32 and the second elongated portions 34a of the scan electrodes 34 are formed below the first dielectric layer 12 of the front substrate 10 and have predetermined line widths W32 and W34, respectively, and have predetermined thicknesses TS1 and TS2 in the z-axis direction, respectively. A second dielectric layer 13 covers the first elongated portions 32a and the second elongated portions 34a.

The first dielectric layer 12 and the second dielectric layer 13 can have substantially the same dielectric constant. A thickness T2 of the second dielectric layer 13 is smaller than a thickness T1 of the first dielectric layer 12.

The first elongated portion 32a and the second elongated portion 34a penetrate into the first dielectric layer 12 when being formed on the first dielectric layer 12. However, since the thickness T1 of the first dielectric layer 12 that covers the address electrode 15 is large, this penetration is not apt to cause a short circuit with the address electrode 15. Since the thickness T2 of the second dielectric layer 13 is small, front area transmittance of visible light emitted from the discharge cells 18 can be improved.

The first floating portion 32b of the sustain electrode 32 and the second floating portion 34b of the scan electrode 34 that are formed below the second dielectric layer 13 and are covered with a third dielectric layer 14. Specifically, the first dielectric layer 12 and the second dielectric layer 13 are formed on the entire surface of the front substrate 10, whereas the third dielectric layer 14 is formed on the second dielectric layer 13 only at locations that correspond to the first floating portions 32b and the second floating portions 34b so that the third dielectric layer 14 encompasses the first floating portions 32b and the second floating portions 34b.

Since the first floating portions 32b and the second floating portions 34b form the opposed discharge structure, luminous efficiency can be improved during the sustain discharge. In a cross-sectional structure of the front substrate 10 and the rear substrate 20 cut in the vertical direction (i.e., the yz plane) corresponding to the individual discharge cells 18, the first floating portions 32b and the second floating portions 34b have a vertical height HV that is larger than a horizontal width HH in order to induce the generation of an opposed discharge for a wider area.

The opposed discharge that is generated in the wider area gives rise to strong vacuum ultraviolet (VUV) rays within the discharge cells 18. The strong VUV rays collide with the phosphor layers 25 in a wide area within the discharge cells 18, so a large amount of visible light is generated.

In the above cross-sectional structure with respect to the yz plane, a cross-sectional area of the first elongated portions 32a is smaller than that of the first floating portions 32b, and a cross-sectional area of the second elongated portions 34a is smaller than that of the second floating portions 34b. The first elongated portions 32a and the second elongated portions 34a are regions to which a voltage signal is applied, and are formed with the smaller cross-sectional areas. Hence, an amount of current consumed during a discharge event can be reduced.

The first elongated portions 32a and the second elongated portions 34a are formed to have a thickness TS1 and a thickness TS2, respectively. The thickness TS1 and the thickness TS2 are smaller than a thickness TA of the address electrode 15. Since the first elongated portions 32a and the second elongated portions 34a are formed with the small thicknesses TS1 and TS2, respectively, their weight is decreased. As the first elongated portions 32a and the second elongated portions 34a are formed on the first dielectric layer 12, which is formed after the address electrode 15 is formed, the first elongated portions 32a and the second elongated portions 34a are less apt to penetrate the first dielectric layer 12 due to their decreased weight to, thereby reducing the chance of a short circuit with the address electrode 15. Therefore, the first elongated portion 32a and the second elongated portion 34a can exert little weight onto the first dielectric layer 12, and thus, the first elongated portion 32a and the second elongated portion 34a do not penetrate the first dielectric layer 12. As a result, the first elongated portion 32a and the second elongated portion 34a does not form a short circuit with the address electrode 15.

During an address period, an address voltage is applied to elongated portions 15a of address electrodes 15, and a scan voltage is applied to second elongated portions 34a of scan electrodes 34. As a result, discharge cells 18 to be turned on are selected. During a sustain period, first elongated portions 32a of sustain electrodes 32 and second elongated portions 34a of scan electrodes 34 are applied with a sustain voltage. Hence, the discharge cells 18 selected during the address discharge exhibit an image. Voltage signals applied to the individual electrodes can be appropriately selected depending on voltage needs.

The scan electrodes 34 are disposed between the protruding portions 15b of the address electrodes 15 to make an address discharge with the address electrodes 15 easy. Two of the protruding portions 15b of each address electrode 15 correspond to a second floating portion 34b of a scan electrode 34. Thus, the scan electrode 34 takes part in the address discharge of a pair of discharge cells 18 neighboring in the y-axis direction.

Since the address electrodes 15 and the scan electrodes 34 are both formed on the front substrate 10, the protruding portions 15b of the address electrodes 15 and the second floating portions 34b of the scan electrodes 34 are disposed very near to each other. This closer arrangement results in formation of discharge gaps GA for the address discharge. Each of the discharge gaps GA between the address electrodes 15 and the scan electrodes 34 is short, and as a result, the address discharge can be executed even with a low voltage.

The third dielectric layer 14 defines discharge spaces 38 corresponding to the discharge cells 18 on the front substrate 10, while encompassing the first floating portions 32b of the sustain electrodes 32 and the second floating portions 34b of the scan electrodes 34 on the first and second dielectric layers 12 and 13 on the front substrate 10. The discharge spaces 38 are actually portions of the discharge cells 18. The third dielectric layer 14 is formed in a matrix structure corresponding to the first barrier rib members 23a and the second barrier rib members 23b of the barrier ribs 23.

Although not illustrated, a protection layer can be formed on the bottom surface of the second dielectric layer 13 and the inner lateral walls of the third dielectric layer 14, which define the discharge space 38. The protection layer can include magnesium oxide (MgO).

In addition, the PDP according to the present embodiment can drive odd-numbered lines and even-numbered lines separately, since the second floating portions 34b of the scan electrodes 34 and the respective protruding portions 15b of the address electrodes 15 correspond to a pair of discharge cells 18 that are adjacent to each other in the y-axis direction. As one example of the aforementioned driving, each of the sustain electrodes 32 and the scan electrodes 34 is driven while distinguishing between odd-numbered lines and even-numbered lines. When odd-numbered lines are driven, a voltage level is lowered to generate a potential difference at the sustain electrodes 32 and the scan electrodes 34 of the odd-numbered lines, and when even-numbered lines are driven, a voltage is applied to generate a potential difference at the sustain electrodes 32 and the scan electrodes 34 of the even-numbered lines. Such a driving method can be implemented using a known driving method, and thus a detailed description thereof will be omitted.

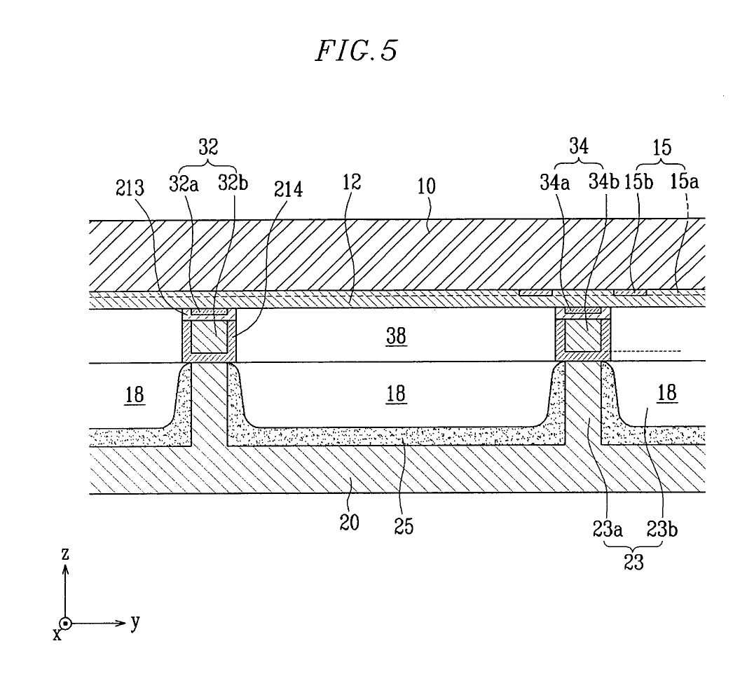

Turning now to FIG. 5, FIG. 5 is a cross-sectional view illustrating a PDP according to the second embodiment of the present invention. Differing from the first embodiment, in the second embodiment, a first dielectric layer 12 is formed on a front substrate 10, and a second dielectric layer 213 and a third dielectric layer 214 are formed corresponding to each of the first floating portions 32b and the second floating portions 34b. Unlike the first embodiment, second dielectric layer 213 does not blanket cover the first dielectric layer 12 but is formed only in the vicinity of the first elongated portion 32a and the second elongated portion 34a. That is, the second dielectric layer 213 encompasses first elongated portions 32a and second elongated portions 34a, and the third dielectric layer 214 encompasses the first floating portions 32b and the second floating portions 34b, which are formed on the second dielectric layer 213. In this second embodiment, since the second dielectric layer 213 is not formed over the discharge cells 18, front area transmittance of visible light can be further improved over that of the first embodiment of the present invention.

According to the embodiments of the present invention, PDP address electrodes, each including an elongated portion and a protruding portion, are formed on a front substrate. Sustain electrodes, each including a first elongated portion and a first floating portion, and scan electrodes, each including a second elongated portion and a second floating portion, are formed in an opposed discharge structure. The sustain electrodes and the scan electrodes are electrically isolated from the address electrodes. The opposed discharge structure allows a voltage signal to be applied to small cross-sectional areas of the first elongated portion and the second elongated portion, and also enables a sustain discharge between the first floating portions and the second floating portions, which have large cross-sectional areas. As a result, luminous efficiency can be improved while limiting an amount of discharge current.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A plasma display panel (PDP), comprising:
a first substrate;
a second substrate facing the first substrate and separated from the first substrate by a distance;
a plurality of discharge cells arranged between the first substrate and the second substrate;
a plurality of address electrodes arranged on the first substrate at locations corresponding to the plurality of discharge cells, the plurality of address electrodes extending in a first direction; and
a plurality of first and second electrodes electrically isolated from the address electrodes and extending in a second direction that crosses the first direction,
wherein each of the plurality of address electrodes includes:
an elongated portion extending in the first direction and
a plurality of protruding portions, each of said protruding portions extending in the second direction from the elongated portion,
each of the plurality of first electrodes includes
a first elongated portion alternately arranged between the discharge cells and extending in the first direction and
a first floating portion arranged on the first substrate to float on the first elongated portion and extend toward the second substrate, and
each of the plurality of second electrodes includes
a second elongated portion arranged between the discharge cells and extending parallel to and alternately with the first elongated portion and corresponding to the protruding portions of the address electrodes and
a second floating portion to float on the second elongated portion and face a first floating portion and extend parallel to the first floating portion and while being between the discharge cells.

2. The PDP of claim 1, wherein each first and each second elongated portion extends in the first direction and within a boundary between a pair of said plurality of discharge cells neighboring in the second direction.

3. The PDP of claim 2, wherein the protruding portions of the address electrodes protrude from the elongated portion corresponding to the discharge cells formed at both sides of respective second electrodes, each of which is taken as a central line.

4. The PDP of claim 1, further comprising:
a first dielectric layer covering the plurality of address electrodes;
a second dielectric layer covering the first dielectric layer and covering the first elongated portion and the second elongated portion arranged on the first dielectric layer; and
a third dielectric layer covering the first floating portions and the second floating portions arranged on the second dielectric layer.

5. The PDP of claim 4, wherein the first dielectric layer and the second dielectric layer are each arranged over an entire surface of the first substrate and the third dielectric layer is arranged at locations corresponding to first floating portions and second floating portions.

6. The PDP of claim 5, wherein the second dielectric layer has a thickness that is smaller than a thickness of the first dielectric layer.

7. The PDP of claim 4, wherein the first dielectric layer is arranged over an entire surface of the first substrate and the second dielectric layer and the third dielectric layer are each arranged at locations corresponding to first floating portions and second floating portions.

8. The PDP of claim 5, wherein the first dielectric layer is arranged over an entire surface of the first substrate and the second dielectric layer and the third dielectric layer are each arranged at locations corresponding to first floating portions and second floating portions

9. The PDP of claim 1, wherein, with respect to a vertical cross-section area of the first and second substrates, the first elongated portion has a cross-sectional area that is smaller than that of the first floating portion.

10. The PDP of claim 1, wherein the first elongated portion has a thickness that is smaller than that of the address electrode.

11. The PDP of claim 1, wherein, with respect to a vertical cross-sectional area of the first and second substrates, the second elongated portion has a cross-sectional area that is smaller than that of the second floating portions.

12. The PDP of claim 1, wherein the second elongated portions have a thickness that is smaller than that of the address electrode.

13. The PDP of claim 1, wherein the first floating portions and the second floating portions are arranged separately on respective ones of the plurality of discharge cells.

14. The PDP of claim 1, further comprising phosphor layers arranged on the second substrate on an inner surface of the plurality of discharge cells.

15. The PDP of claim 1, a thickness of each of the first and the second floating portions being greater than a width of each of the first and the second elongated portions.

16. A plasma display panel (PDP), comprising:
a first substrate;
a second substrate facing the first substrate and separated from the first substrate by a distance;
a plurality of barrier ribs arranged between the first and the second substrate and adapted to partition a space between the first and the second substrates into a plurality of discharge cells;
phosphor layers arranged on the rear substrate and on sidewalls of the plurality of barrier ribs within the plurality of discharge cells;
a plurality of address electrodes arranged on the first substrate in a first direction, the address electrodes being covered by a first dielectric layer; and
an elongated portion of a sustain electrode and an elongated portion of a scan electrode formed on the first dielectric layer and extending in a second direction that crosses the first direction and being covered by a second dielectric layer, the plurality of barrier ribs being arranged between each of the elongated portions of the sustain and scan electrodes and the rear substrate.

17. The PDP of claim 16, further comprising:
a floating portion of the sustain electrode arranged on the second dielectric layer at a location that corresponds to the elongated portion of the sustain electrode;
a floating portion of the scan electrode arranged on the second dielectric layer at a location that corresponds to the elongated portion of the scan electrode; and
a third dielectric layer that covers the floating portions of each of the sustain and the scan electrodes, the floating portions of each of the sustain and the scan electrodes being further from the rear substrate than the plurality of barrier ribs, the floating portion and the elongated portion of each of the sustain and the scan electrodes being arranged above the plurality of barrier ribs and not above the plurality of discharge cells.

18. The PDP of claim 17, the elongated portion of each of the sustain and the scan electrodes being thinner than the address electrodes, the floating portion for each of the sustain and the scan electrodes being thicker than the address electrodes and being thicker than a width of floating portions of each of the sustain and the scan electrodes.

19. The PDP of claim 16, each of the plurality of address electrodes comprise an elongated portion arranged above ones of the plurality of barrier ribs and a plurality of protruding portions, each extending from an elongated portion into a region above ones of the plurality of discharge cells.

20. The PDP of claim 19, the protruding portions being arranged in pairs, ones of each pair being arranged on either side of a scan electrode and over separate discharge cells.
